(19) United States
(12) Patent Application Publication
(10) Pub. No.: US 2011/0078970 A1
(43) Pub. Date: Apr. 7, 2011

(54) CEILING TILE AND EDGE SUSPENSION SYSTEM

(75) Inventor: Alan L. Boyd, Collegeville, PA (US)

(73) Assignee: CERTAINTEED CORPORATION, Valley Forge, PA (US)

(21) Appl. No.: 12/571,902

(22) Filed: Oct. 1, 2009

(51) Int. Cl. E04B 9/24; E04B 9/04; F16B 2/20; E04G 21/00

(52) U.S. Cl. 52/506.07; 24/303; 52/745.05

(57) ABSTRACT

A rectangular ceiling tile to be supported in an exposed type suspended grid system of perpendicularly crossed girders of inverted T-profile. The tile includes a core containing fiber material with two opposite first edges, each forming a recess, and two opposite second edges each forming a recess. The tile forms a projecting, peripheral rim on a lower face of the tile. At least two edge support clips are provided. Each clip has one or more limbs that are inserted into or under a transverse edge surface of the core. Each clip has a magnetic member extending parallel to or coplanar with a major face of the core

U.S. patent application Ser. No. 12/210,521, filed Sep. 15, 2008 is incorporated by reference herein in its entirety.

### FIELD OF THE INVENTION

This invention relates to ceiling tiles supported in an exposed-type suspension grid system of perpendicularly crossed girders of inverted T-profile.

### BACKGROUND

Ceiling tile suspension systems have been provided for ceiling construction with improved appearance that is derived from a suspension grid that is largely concealed by the ceiling tiles themselves. This has been accomplished by diminishing the exposure of the girders by having them recess into the side edges of the tiles. Typically, this is accomplished by using a tile made of a core of fibrous material with two opposite first edges each forming a stepped groove having a deeper section and a shallower section, and two opposite second edges each forming a stepped groove. While the tile is mounted in the grid system, the flanges of the girders extending along the first edges are received by the shallower section of the stepped grooves and support the tile in the grid system. Such systems are generally described in Moller, U.S. Pat. No. 6,389,771; Bodine, U.S. Pat. No. 6,108,994; and Wendt et al., U.S. Pat. No. 6,260,325, which are hereby incorporated by reference.

The standard cut edges described in the references are complex, with many surfaces that are difficult to paint and seal. Exposed fiberglass edges are not desirable in high-end fiberglass ceiling panels. Accordingly, there remains a need for a better tile for simplifying the construction and installation of exposed-type suspension grid systems.

### SUMMARY OF THE INVENTION

In some embodiments, a rectangular ceiling tile is configured to be supported in an exposed type suspended grid system of perpendicularly crossed girders of inverted T-profile. The tile includes a core containing fiber material with two opposite first edges, each forming a recess, and two opposite second edges each forming a recess. The tile forms a projecting, peripheral rim on a lower face of the tile. At least two edge support clips are provided. Each clip has one or more limbs that are inserted into or under a transverse edge surface of the core. Each clip has a magnetic member extending parallel to or coplanar with a major face of the core

In some embodiments, an edge support clip is provided for ceiling tiles supported in an exposed type suspended grid system of perpendicularly crossed girders of inverted T-profile. The clip includes one or more limbs that can be inserted into a transverse edge of the ceiling tile. A web is connected to the one or more limbs. The web has a protruding ledge, the protruding ledge including a magnetic member for attaching said tile to a flange of a ceiling suspension girder of inverted T-profile by magnetic attraction.

In some embodiments, a method is provided for installing a rectangular ceiling tile in an exposed type suspended grid system of perpendicularly crossed girders of inverted T-profile. The method comprises providing a ceiling tile including a core containing fiber material with two opposite first edges each forming a stepped recess, and two opposite second edges each forming a stepped recess. The tile forms a projecting, peripheral rim along said first and second edges. At least one edge support clip is inserted on each of the two opposite first edges. The clips each have one or more limbs that are inserted into or under a transverse edge surface of said core. Each clip has a protruding ledge. The protruding ledge of each of the clips extends parallel to or coplanar with a major face of the core. The protruding ledge of each clip includes a magnetic member. A surface of a first flange of said girders is contacted with the magnetic member of the at least one edge support clip of a first one of the first edges, so as to attach the first edge to the first flange by magnetic attraction. A surface of a second flange of said girders is contacted with the magnetic member of the at least one edge support clip of a second one of the first edges, so as to attach the second one of the first edges to the second flange by magnetic attraction, thereby suspending the ceiling tile.

### BRIEF DESCRIPTION OF THE DRAWINGS

The present invention will be described in more detail with reference to the accompanying drawings which disclose an illustrative embodiment of the invention:

FIG. 1: is a perspective view of a suspended ceiling grid;

FIG. 2: is an enlarged cross-sectional view with tiles along line 2-2 in FIG. 1;

FIG. 3: is a top planar view of a generally C-shaped edge supporting clip of one embodiment of this invention;

FIG. 4: is a front planar view of the support clip of FIG. 3;

FIG. 5: is a side elevation view of the support clip of FIG. 3;

FIG. 6: is a bottom planar view of the support clip of FIG. 3;

FIG. 7: is a bottom perspective view of an additional support clip embodiment having a flush tab extension;

FIG. 8: is a top perspective view of the clip of FIG. 7; and

FIG. 9: is a side elevation view of the clip of FIG. 7.

FIG. 10 is a cross sectional view of a portion of a ceiling, including an embodiment of a clip having a magnetic member.

FIGS. 11A-11C are top plan, side and bottom plan views, respectively, of the clip shown in FIG. 10.

FIG. 12 is a cross sectional view of a portion of a ceiling, including a variation of the clip of FIGS. 11A-11C.

FIG. 13 is a side view of the clip shown in FIG. 12.

FIGS. 14 and 15 show a variation of the clip shown in FIG. 3.

### DETAILED DESCRIPTION

In a first embodiment, a rectangular ceiling tile is provided. The ceiling tile is to be supported in an exposed-type suspension grid system of perpendicularly crossed girders of inverted T-profile. The tile includes a core containing fiber material with two opposite first edges, each forming a stepped recess, and two opposite second edges each forming a stepped recess. The tile includes a projecting, peripheral rim on the lower face thereof, alongside the first and second edges. The tile further includes at least two oppositely disposed generally C-shaped edge support clips, each having one or more limbs that are inserted into the core in a transverse edge surface thereof. Each of the clips also includes a web forming a protruding edge having a stepped groove, the groove having a deeper section and a shallower section. The protruding edge of each of the clips extends transversely of the transverse edge of the tile.

Accordingly, the ceiling tile and systems are designed to replace the complex and difficult to paint edge detail of prior art downwardly accessible ceiling panels with a simpler cut and provide a support clip shaped to mimic the complex cut edge. This avoids the costs associated with cutting the complex tile edge with a saw tool, along with the costs associated with painting and sealing all of those exposed edge surfaces, which sometimes remain uncoated on current tiles.

The use of the C-shaped clips can also be positioned to compensate for panel thickness variation, and can be custom sized for various suspension grid types and sizes. The clips can also be used to provide additional support to the panel, alleviating a potential for sagging or bowing. These clips, desirably, are also not visible when viewing the ceiling or tile from the normal vantage point of a typical room. Finally, the preferred clips are shaped to mimic the complex cut edge of existing tiles, such as Ecophon DG, C, and D edge profile commercial tiles.

In the preferred embodiment, the entire tile can be sealed or encapsulated in paint, including both faces and along all four edges. The two machined edges, having a complex two-step cavity of prior art tiles, can be replaced with simpler L-shaped edges, so that all four sides of the tile include an L-shaped edge, for example. The C-shaped clips can be inserted into a pair of opposite sides of a tile, or into all four sides having these L-shaped edges. The clips can also be adjusted to permit installation in grids that are out of square. The systems and clips can be used with fiberglass or low density mineral boards.

In a further embodiment, a generally C-shaped edge support clip for ceiling tiles is provided. The clip can be supported in an exposed type suspension grid system of perpendicularly crossed girders of inverted T-profile. These clips include a metallic or plastic material, one or more limbs that can be inserted into a transverse edge of a ceiling tile, a web forming a protruding ridge having a deeper stepped groove that permits downward access for mounting and demounting the tile and a shallower section for allowing the clip to rest on a flange of a ceiling suspension grid.

In still a further embodiment, a method of installing a rectangular ceiling tile in an exposed-type suspension grid system of perpendicularly crossed girders of inverted T-profile is provided. The method includes providing a ceiling tile including a core containing fiber material with two opposite first edges each forming a stepped recess, and two opposite second edges each forming a stepped recess, the tile forming a projecting, peripheral rim on the lower face thereof, along the first and second edges. The method further includes inserting at least two generally C-shaped edge support clips into each of said two opposite first edges. These two generally C-shaped clips each include one or more limbs that are inserted into the core along a transverse edge surface of said ceiling tile. Each C-shaped clip has a web forming a protruding edge having a stepped groove having a deeper section and a shallower section, said protruding edge of each of said clips extending transversely of the transverse edge of the tile. The method further includes supporting a first of said two opposite first edges comprising one of at least two generally C-shaped edge support clips onto a first girder flange of said girder so as to insert said girder flange into said deeper section of said step groove. The method further includes lifting the rectangular ceiling tile so that a second of the two opposite first edges comprising a second of at least two generally C-shaped edge support clips is disposed above a second girder flange and finally, transversely sliding said rectangular ceiling tile whereby said first and second girder flanges come in contact with the shallower sections of each of said first and second generally C-shaped edge support clips to support said rectangular ceiling tile within said grid system.

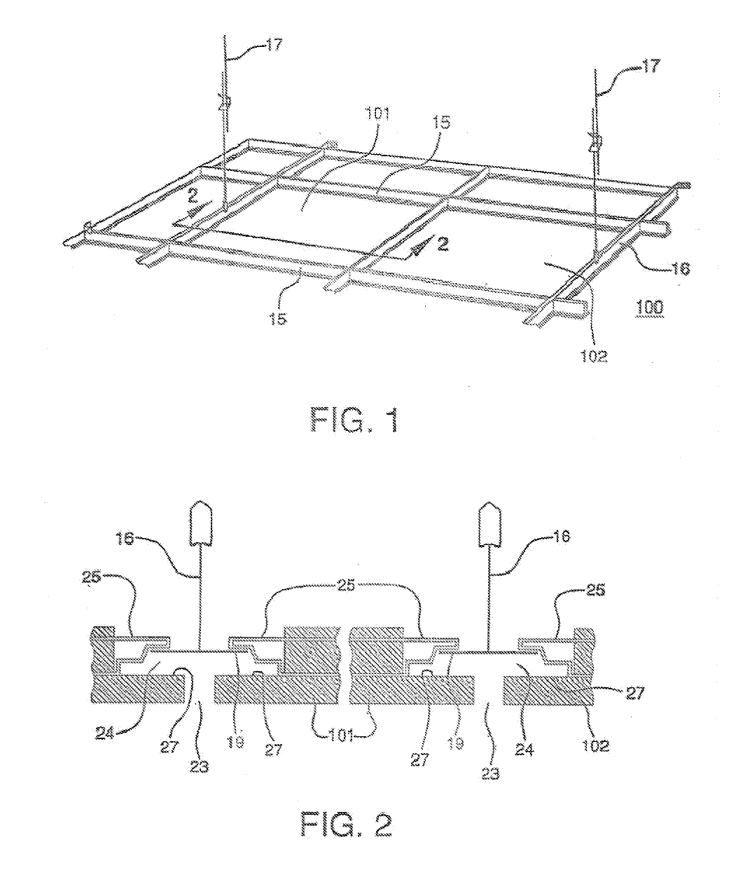

With reference to the figures and particularly to FIGS. 1 and 2, there is shown a suspended ceiling 100 with an exposed grid system which comprises perpendicularly crossed sheet metal or extruded aluminum girders including main runners 15 and cross runners 16 both of inverted T-profile. The grid system is suspended by means of hangers 17. In the rectangular windows formed by the grid system 100, tiles 101 and 102 are mounted which comprise a core of fiber material such as glass wool, glass textile fibers, mineral fibers, paper fiber, or gypsum, or a combination thereof, having a surface layer on one or both faces thereof. The surface layer or layers of the tiles 101 and 102 can be a woven or non-woven glass mat, or a woven or non-woven resinous (such as polyolefin) or natural fiber mat or fabric, (such as a textile of woven cotton fibers), and adhered to the first and/or second major surfaces of the tiles 101 and 102.

As shown in FIG. 2, a rectangular ceiling tile 101 is supported in an exposed-type suspended grid system of perpendicularly crossed girders 16 of inverted T-profile. The tile includes a core of fiber material with two opposite first edges, each forming a stepped recess, and two opposite second edges, each forming a stepped recess, for example, having a general “L” shaped cross-section having a transverse vertical edge and a horizontal top edge 27. The tile 101 forms a projecting, peripheral rim on the lower face thereof, alongside the first and second edges. Disposed into the fiber material of the core along the transverse edge surface of the stepped two opposite first edges is a pair of generally C-shaped support clips 25. Each of these support clips 25 include one or more limbs that are inserted into the fiber material of the core in a transverse edge surface thereof. Each of the support clips 25 also includes a web forming a protruding ridge having a stepped groove, having a deeper section 205 and narrower section 208 as described by the plastic edge support clip 200 shown in FIG. 5. The protruding edge of each of the clips 25 or 200 extends transversely of the transverse edge of the tile 101 into which it is inserted. Upon final installation, the stepped groove formed in the web of each clip 25 permits the clip 25 to rest on a flange 19 of a girder 16 of inverted T-profile. Typically, the shallower section 208 of the stepped groove of clip 200 permits the clip to rest on the flange 19 while the deeper section 205 of the stepped groove of clip 200 permits a downward access clearance for mounting and demounting the tiles 101 and 102. Alternatively, less desirable structures for the generally C-shaped support clips 25 could include clips that have a larger single step or projection for mounting the tiles 101 and 102 and providing downward access.

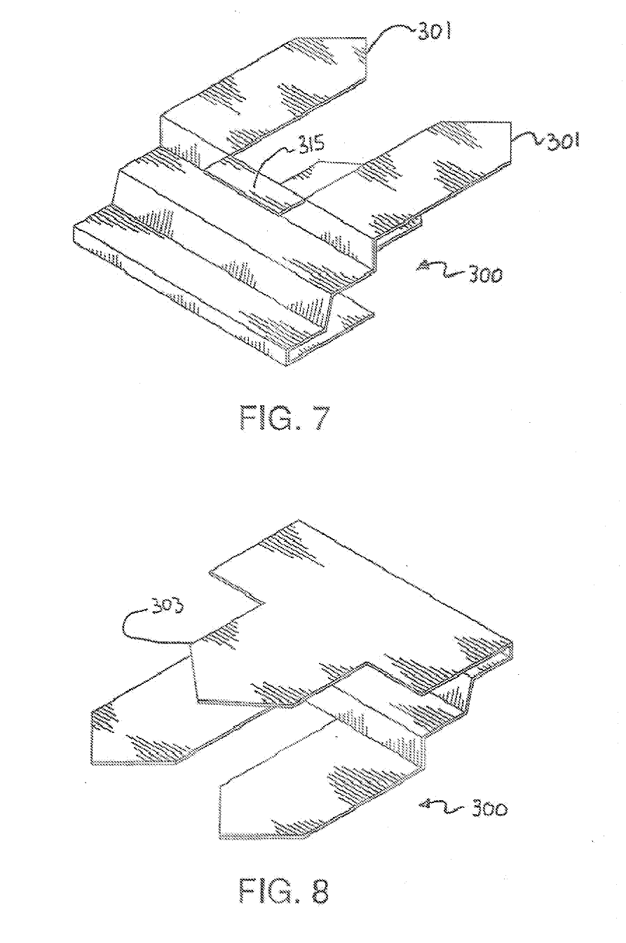

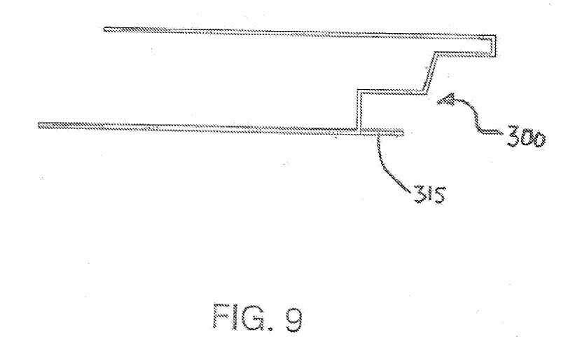

The edge clips 25, 200, and 300 disclosed in FIGS. 2-9, can be made of sheet spring steel, galvanized steel, stainless steel, cold-rolled steel, aluminum, or plastic, such as polyethylene, polystyrene or pvc, with or without reinforced fibers, such as glass fibers. In some embodiments, the clips 25, 200 and 300 comprise a magnetic material, such as nickel, iron, cobalt, gadolinium or their alloys. A clip formed of a magnetic material has additional positional stability after installation. The protruding edge 208 provides a ledge that rests on and is magnetically attracted to the flange 19 of the girder of inverted T profile. Any of the clips describe herein and shown in FIGS. 2-9 may be formed from a permanent magnetic material.

The clips 25, 200 and 300 form a generally C-shaped profile. The clips 25, 200 and 300 can include one or more limbs such as bayonet-shaped prongs 201 and 203. The prongs can be in single form, such as prongs 203 and 303, or in multiple prongs such as prongs 201 and 301. There can be more prongs located at the bottom of the clip 200 and 300 than at the top of the clip 200 and 300, and vice versa. The prongs may have a tapered leading edge so that insertion into the core of the tile 101 can be facilitated.

Clip 300 is designed to further support the “L” shaped edge or recess of the ceiling tile 101 during use. Clip 300 has a flush tab 315 which extends along the top surface of tile 101 and supports it against breakage and bending. This is an added accommodation in the event lower density boards or thinner extended flanges are used. The clip 300 is otherwise similar in geometry and purpose to clip 200.

In a further embodiment, the clip 200 can include optional reinforcing bumps 202 and 203 which help to reinforce thin sheet metal or plastic when it is being crushed into the core of tiles 101 and 102. In this manner, the thickness of the clip material can be reduced to conserve on material costs. The edge support clips 25, 200 and 300 have a width of 0.5-4 inches, preferably 1-2 inches, and most preferably about 1.5-2 inches, and a length of about 1-3 inches, most preferably about 1.5-2 inches. The thickness of the clip will be dictated by the material stiffness and the substrate into which it will be stabbed. The preferred material, galvanized steel, will generally be about 25 to 27 gauge, or about 0.016 to 0.020 inches in thickness to allow the clip to be stiff, but still be thin enough to allow it to be stabbed efficiently and cleanly into the core of the transverse edge of tiles 101 and 102. The tiles 101 and 102 can be made of fiberglass or mineral board, for example.

The top surface of the clips 200 and 300 can be solid or slotted to appear to have two or more legs. The transverse edge of the tile 101 would receive the clip 25, 200 or 300, and the clip would support the panel such that the clip 25, 200 or 300 would rest on the flange 19 of the ceiling suspension grid, and allow the downwardly accessed steps necessary to mount and de-mount the panel. Two or more such clips 25, 200 or 300 would be inserted in opposite edges of the panel. The remaining two panel edges can remain unsupported, as in current practice.

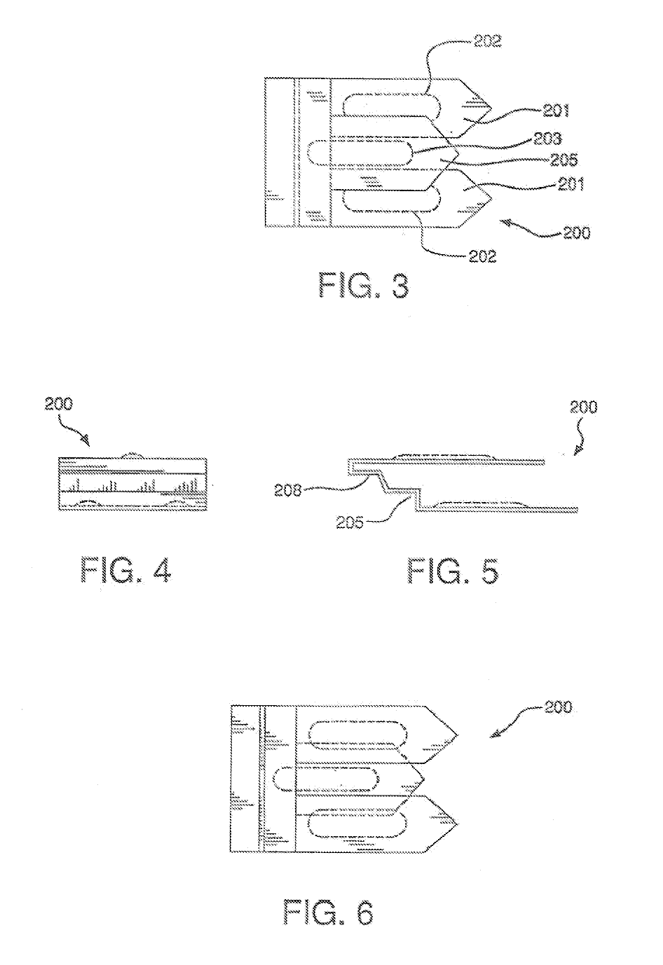

FIGS. 14 and 15 show another variation of the clip 600, having top and bottom limbs 605 and 601, respectively and a narrower portion 610. Clip 600 is similar to the clip 200 shown in FIGS. 3-6. However, as shown in FIGS. 14 and 15, optional, “lances” 608, 609 may be provided in the prongs 601 and 605, respectively. Lances 608, 609 are small bent protrusions or tabs that make it slightly more difficult to pull the clips 600 out of the edge of the panels, once the clips are inserted. Lances 608 project upward from the bottom prongs 601, and lances 609 project downward from the upper prong(s) 605. The lances 608, 609 may be stamped from a sheet of metal that is formed into clip 600. For example, the clip 600 may be made from 0.014″ to 0.016″ hot dipped galvanized cold rolled steel. In some embodiments, clip 600 may be molded or cast with the lances 608, 609 included. In some embodiments, the clip 600 comprises a magnetic material, such as nickel, iron, cobalt, gadolinium or their alloys, or the clip may contain a magnetic member within the narrower portion 610.

The clips 25, 200, 300 and 600 enable the ceiling tile 100 or 102 to be fabricated more simply than the current practice of cutting a complex stepped edge into the entire length of the board side. This simpler edge is generally “L” shaped, and is then easier to coat or paint. This will reduce manufacturing costs. The clips 25, 200 and 300 will generally not be visible when viewing the ceiling panel or tile 101 or 102 from the normal vantage point of below the drop ceiling in a typical room. When the system is complete, the tiles 101 and 102, clips 25 and flanges 19 of the girder 16, form a cavity 24 and a spacing 23 between tiles 101 and 102. The extended edge of the tiles 101 and 102 can be designed so that they are substantially touching, which would eliminate the space 23. Generally, there will be a space 23 formed between adjacent tiles, but insufficient light in the cavity 24 to allow an observer to readily see the clips 25.

In practice, a first edge of a tile 101 having one or two generally C-shaped metal or plastic edge support clips 25 on each of two opposite first edges is supported on a first girder flange 19 so as to insert the girder flange 19 into the deeper section of the stepped groove 205. Next, the ceiling tile 101 is lifted so that a second of the two opposite first edges comprising at least one or two, for example, generally C-shaped metal or plastic edge support clips 25 is disposed above a second girder flange 19. Then, the ceiling tile 101 is transversely slid whereby the first and second girder flanges 19 come in contact with the shallower sections, generally 208 of clip 200 shown in FIG. 5, of each of the first and second ones or sets of the generally C-shaped metal or plastic edge support clips 25 to support the rectangular ceiling tile 101 within the grid system, as shown in FIG. 2.

In some methods of inserting tiles 101 into the grid systems, at least four generally C-shaped metal or plastic edge support clips 25 or 200 are inserted into a tile 101, whereby at least two generally C-shaped clips 25 or 200 are inserted into the core of the fiber material along each of two opposite first edges, more preferably into a transverse cut of a tile 101 being made of a fiberglass board.

Ideally, the C-shaped metal or plastic edge support clips 25 or 200 are inserted so that the deeper section 205 of its step groove is disposed below its shallower section 208.

A preferred ceiling tile 101 comprises a core of fiber material with two opposing first edges and two opposing second edges, each of the first and second edges form a stepped recess having a substantial vertical transverse edge surface and a top edge surface 27. The vertical transverse edge and the top edge surfaces 27 forming an inside corner of the stepped recess, or “L” shape, said inside corner being substantially completely covered in paint. Whereas the complex shape of conventionally sold ceiling tiles having a double stepped groove are difficult to paint and often include an unpainted surface which is generally invisible to one inspecting the tile from below, but problematic from a quality control perspective, providing a tile 101, which is substantially completely covered in paint, is an improvement over the prior art. As used herein, the terms “substantially completely covered in paint” means that there are generally no large or continuous areas of uncoated fiberglass, but there may remain individual fiberglass fibers which are uncovered, or small pinholes which are uncovered in paint. For products where two sides are supporting and two sides are non-supporting, the top surface 27 of the L-shaped transverse edge, or horizontal edge, will generally be about 16 mm (0.630 inches) wide on the sides that will be receive the clip 25 or 200. The other two sides will have a flange or top surface 27 of approximately 8.5 mm (0.335 inches) wide. These dimensions will result in a gap 23 between the tiles 101 and 102 of about 5/16 inches. If the top surfaces 25 of the L-shaped transverse edge are all made wider, they can be made to come together and conceal the girders 16 completely, or one can vary the transverse edge top surface 27 dimensions to make the gaps 23 any width desired, from a max of about ⅝ inches to about zero. In the case of a ⅝ inch gap, the dimensions of the top surface 27 would be essentially zero.

The core of the fiberglass material used for making the tiles 101 can include textile fibers, rotary glass fibers or both bonded by a resinous adhesive. A woven or non-woven mat, vinyl layer or decorative laminate can be disposed on a first major surface, a second major surface, or both major surfaces of the ceiling tiles 101 and 102. Generally, a non-woven fiberglass mat composed of random-oriented glass fibers bonded by a resinous adhesive is preferred. The rectangular ceiling tiles 101 and 102 can include a top edge surface 27 of two opposing first edges having a lateral dimension which is greater than the lateral dimension of the top edge surfaces of two opposing second edges. They can also have top edge surfaces 27 of equal dimensions to the top edge surfaces 27 of the two opposing second edges.

Normally, due to the complexity of the multi-step cut that characterizes the Ecophon DG-type edge, a manufacturer needs to use a relatively high density fiberglass board (e.g., 5 to 6 pounds per cubic foot). The high density allows the cut to be more precise and “clean”, gives a much better surface to apply paint to (i.e., it is less absorbent than if a lower density fiberglass board is used), and the relatively small “lip” that supports the panel on the grid flange is strong enough to support the weight of the panel. This example allows a heretofore high end edge detail (Ecophon DG or D type) to be obtainable on less expensive fiberglass coreboards. Commonly today, reveal edge panels (panels that have a recess around the perimeter to allow the panel face to extend below the plane of the grid) are made from a board having a density of less than 5 pounds per cubic foot, e.g., a 4 pound per cubic foot fiberglass board. This density of board can be used to make DG type boards, but it is marginal in quality (most likely not acceptable) because the lower density board does not accept the complex DG cut very well (it's not a very clean cut), and it is even more absorbent, and therefore difficult to paint than when the 6 pound per cubic foot fiberglass is used.

In the case of 4 pound per cubic foot fiberglass, we can make the simplified L-shaped cut described herein, and use the clip 25 to complete the product. The result is a high-quality product without using the much more expensive 6 pound per cubic foot fiberglass board. An acceptable product may also be made with 2.7 to 3.0 pound per cubic foot glass, which is considered the very low end, commodity type of board. This would allow the high-end DG look to be available to builders or homeowners who may not otherwise be able to afford it.

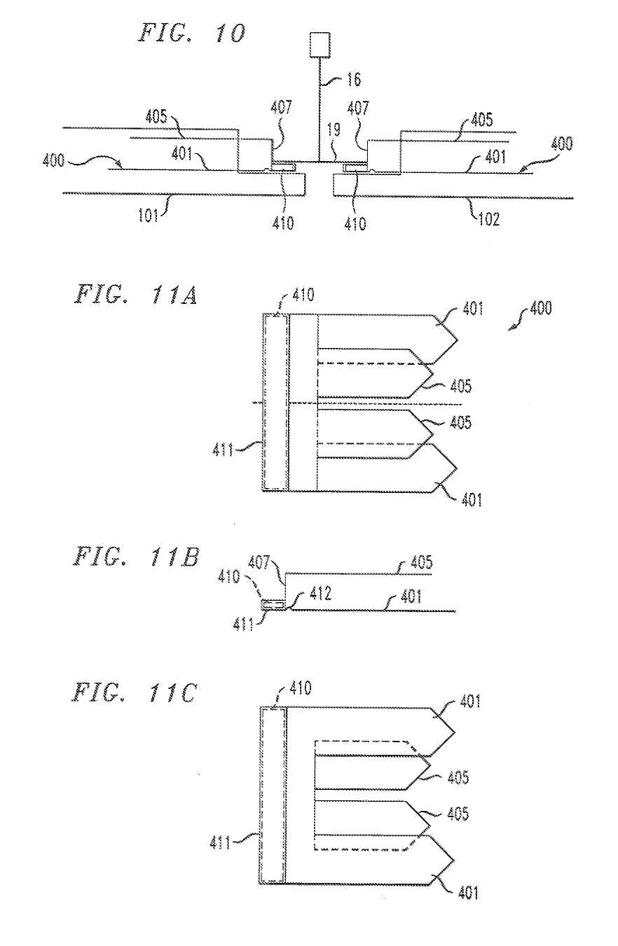

FIGS. 10 to 13 show an embodiment of a clip 400, 500 that includes one or more magnetic members 410 for mounting the ceiling tiles 101, 102 to the flange 19 of a girder 16 of inverted T-profile.

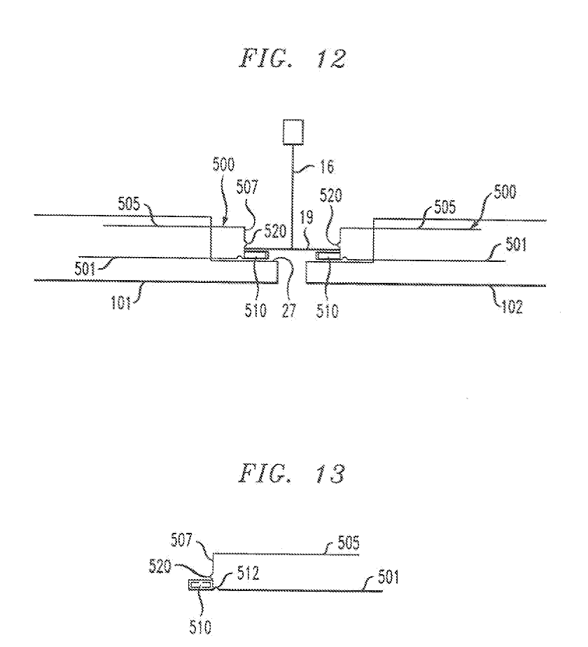

Referring to FIGS. 10 and 11A-11C, disposed into the fiber material of the core of the tiles 101, 102, along the transverse edge surface of the stepped two opposite first edges is a pair of generally C-shaped support clips 400. Each of these support clips 400 include one or more limbs 401, 405 that are inserted into the fiber material of the core in a transverse edge surface thereof. Each of the support clips 400 also includes a web 407 joining the limbs 410 and 405, as shown in FIG. 11B. The web 407 has a protruding ledge 411 with a tubular opening containing a magnetic strip 410 therein. The protruding ledge 411 of each of the clips 400 extends transversely of the transverse edge of the tile 101 into which it is inserted. The protruding ledge 411 of each of the clips 400 extends parallel to or coplanar with a major face of the core. Upon final installation, the ledge 411 of the web of each clip 400 permits the clip 400 to attach itself by magnetic attraction to the bottom-surface of a flange 19 of a girder 16 of inverted T-profile.

In the configuration of FIG. 10, the ledge 411 is concealed following installation, as is a majority portion of the surface of the flange 19. Optionally, one of ordinary skill in the art can readily increase the width of the peripheral rim of the tile 101, 102, so that the entire bottom surface of the flange 19 is concealed.

The magnetic strips 410 are permanent magnet strips comprising a ferromagnetic material, such as nickel, iron, cobalt, or their alloys, such as a transition metal-metalloid alloy, made from about 80% transition metal (usually Fe, Co, or Ni) and a metalloid component (B, C, Si, P, or Al).

The limbs 401, 405 and web 407 of clip 400 may comprise a variety of materials that are paramagnetic (relative magnetic permeability greater than 1.0) or materials that do not interfere with the magnetic field of magnetic strips 410. These materials include a variety of steels and plastic materials such as polyethylene, polystyrene or pvc, with or without reinforced fibers, such as glass fibers. The clip 400 may be molded or cast, and the magnetic strip 410 may be press-fitted into the elongated tubular opening of the ledge 411.

In some embodiments, the clips 400 are about 5 cm (2″) wide, with the magnetic strips 410 extending throughout the length of the clips 400. The magnetic strips 410 may be about 6 mm (0.25″) wide and about 1.5 mm (0.06″) thick. In some embodiments, six, eight or nine clips may be included for each tile. In other embodiments, a total of 12 clips 400 (three clips 400 per side) may be used to mount a 60 cm×60 cm (2 ft×2 ft) fiber glass ceiling tile 101, 102. One of ordinary skill in art can readily vary the number of clips used per side, depending on the size and weight per unit area of the tiles, and the size and strength of the magnetic strips.

Although the clip example of FIGS. 10-11C has two pieces (a clip 400 of a first material having a ledge 411 with a tubular opening, and a magnetic strip 410 of a second material inserted in the tubular opening), other embodiments (not shown) include a single member, made of a permanent magnet material. The single member has the same outline as shown in FIGS. 11A-11C, but the ledge 411 is a continuous solid without an opening.

As shown in FIG. 10, the protruding ledge 411 of clip 400 is located at the bottom of the clip, so that the ledge 411 abuts and reinforces the peripheral rim of the tile 101, 102. In other embodiments (not shown), the ledge 411 may be positioned at the top of the web 407, or at an intermediate position between the bottom and top of the web 407. In other embodiments (not shown), the protruding ledge may extend up above the top of the web 407, for example to be co-planar with the top surface of the tile 101, 102. Further, a variety of clips having magnetic members may be used having different shapes that include a flat horizontal surface shaped to self-attach by magnetic attraction to a surface (e.g., a bottom surface or a top surface) of a flange of a girder of inverted T-profile.

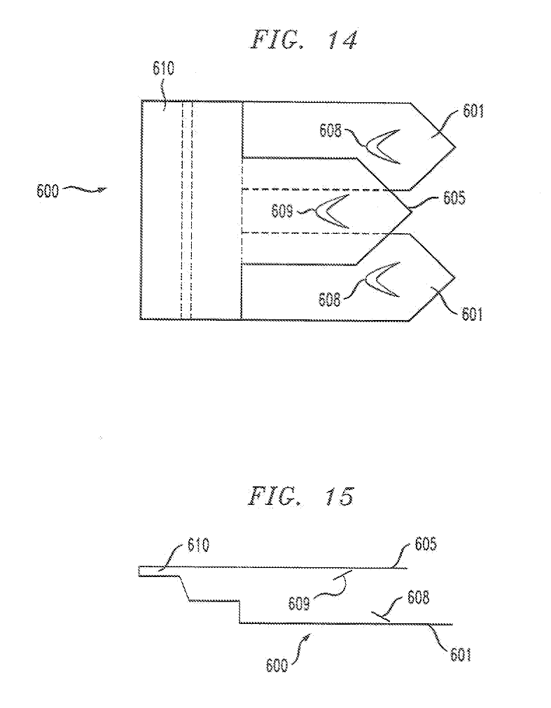

FIGS. 12 and 13 show clip 500 which is a variation of the clip 400. Items in FIGS. 12 and 13 which are the same or similar to items in FIGS. 10-11C are indicated by like reference numerals increased by 100. Clip 500 includes a plurality of limbs 501, 505 connected by a web 507 having a ledge 511. The ledge 511 contains a permanent magnet strip 510. Limbs 501, 505, ledge 511 and magnet strip 510 may be the same as or similar to the corresponding limbs 401, 405, ledge 411 and magnet strip 410 described above, and descriptions thereof are not repeated. Web 507 differs from web 407 in that at least one protrusion 520 is provided. As best seen in FIG. 12, during installation, the at least one protrusion 520 is seated above the flange 19 of the inverted-T profile 16. The at least one protrusion 520 imparts a small lifting force on the edge of the tiles 101, 102, making it more secure. The at least one protrusion 520 provides a slight increase in the effort to remove the tiles 101, 102, compared to tiles mounted using the clip 400.

The at least one protrusion 520 may have a variety of forms. For example, the protrusion 520 may include one or more round bumps having a diameter of 2-4 mm (0.08″ to 0.17″). Alternatively, the protrusion may include bumps having a different shape, such as an ellipse or rectangle. Alternatively, the protrusion may be an elongated bump extending along a substantial portion (e.g., 25 to 50 mm, 1″ to 2″) of the web 507.

The examples shown in FIGS. 10-13 have limbs that are inserted into a transverse edge of the core. In other embodiments, the limbs 405, 505 may be modified to fit over the top of the core 101, 102. In the case of a core having an upper rim on its transverse edge (such as the core 12 shown in U.S. Pat. No. 6,260,325), the limbs 401, 501 of the clips 400, 500 can be modified to fit under the top rim of the transverse edge of the core. Such modifications involve varying the spacing between the bottom limbs 401, 501 and the top limbs 405, 505, and/or Thus, the clips having a projecting ledge 411 with a magnetic member 410 can be configured to be inserted into or under the transverse edge.

Improved ceiling tiles, clips for ceiling tiles, and systems for supporting ceiling tiles in exposed type suspension grid systems are described herein. The clips and systems described herein enable ceiling tile board edges to be fabricated more simply than with the current practice of cutting a complex edge into the entire length of the board side. This simpler edge is then easier to coat or paint, and reduces manufacturing costs.

1. A rectangular ceiling tile to be supported in an exposed type suspended grid system of perpendicularly crossed girders of inverted T-profile, said tile comprising:
a) a core containing fiber material with two opposite first edges, each forming a recess, and two opposite second edges each forming a recess, the tile forming a projecting, peripheral rim on a lower face thereof; and
b) at least two edge support clips, each having one or more limbs that are inserted into or under a transverse edge surface of the core, and each having a magnetic member extending parallel to or coplanar with a major face of said core.

2. The ceiling tile of claim 1, wherein the edge support clips each have a web connected to the one or more limbs, the web including a protruding ledge, said protruding ledge of each of said clips including the magnetic member thereof.

3. The ceiling tile of claim 2, wherein said protruding ledge includes a tubular opening extending parallel to the transverse edge of the core, and the magnetic member includes a strip of a permanent magnet material inserted in the tubular opening.

4. The ceiling tile of claim 2, wherein said protruding ledge of the clip has a flat horizontal surface shaped to self-attach by magnetic attraction to a bottom surface of a flange of a girder of inverted T-profile upon contact with the bottom surface.

5. The ceiling tile of claim 4, wherein the web has at least one bump located so as to be positioned above the flange when the flat horizontal surface is attached to the bottom surface of the flange.

6. The ceiling tile of claim 1 wherein the magnetic members abut a surface of the peripheral rim of the core to act as a reinforcement for the peripheral rim.

7. The ceiling tile of claim 1, wherein the limbs of at least one of the clips include a lance for retaining the clip in the core.

8. An edge support clip for ceiling tiles supported in an exposed type suspended grid system of perpendicularly crossed girders of inverted T-profile, said clip comprising:
one or more limbs that can be inserted into or under a transverse edge of said ceiling tile;
a web connected to the one or more limbs, the web having a protruding ledge, the protruding ledge including a magnetic member for attaching said tile to a flange of a ceiling suspension girder of inverted T-profile by magnetic attraction.

9. The clip of claim 8 wherein said protruding ledge includes a tubular opening extending parallel to the transverse edge of the ceiling tile, and the magnetic member includes a strip of a permanent magnet material.

10. The clip of claim 8, wherein the web has at least one bump located so as to be positioned above the flange with the protruding ledge attached to the bottom surface of the flange.

11. The clip of claim 8 wherein said at least one limb comprises a bayonet-shaped prong.

12. The clip of claim 8 wherein said magnetic member of the clip has a flat horizontal surface shaped to self-attach to a bottom surface of the flange.

13. The ceiling tile of claim 8, wherein the limbs of at least one of the clips include a lance for retaining the clip in the ceiling tile.

14. A method of installing a rectangular ceiling tile in an exposed type suspended grid system of perpendicularly crossed girders of inverted T-profile, said method comprising:
a) providing a ceiling tile including a core containing fiber material with two opposite first edges each forming a stepped recess, and two opposite second edges each forming a stepped recess, the tile forming a projecting, peripheral rim along said first and second edges;
b) inserting at least one edge support clip on each of said two opposite first edges, said clips each having one or more limbs that are inserted into or under a transverse edge surface of said core, and each having a protruding ledge, said protruding ledge of each of said clips extending parallel to or coplanar with a major face of the core, said protruding ledge of each of said clips including a magnetic member;
c) contacting a surface of a first flange of said girders with the magnetic member of the at least one edge support clip of a first one of the first edges, so as to attach the first edge to the first flange by magnetic attraction; and
d) contacting a surface of a second flange of said girders with the magnetic member of the at least one edge support clip of a second one of the first edges, so as to attach the second one of the first edges to the second flange by magnetic attraction, thereby suspending the ceiling tile.

15. The method of claim 14 wherein said protruding ledge of at least one of the clips includes a tubular opening extending parallel to the transverse edge of the core, and the magnetic member includes a strip of a permanent magnet material.

16. The method of claim 14 wherein said protruding ledge of the clip has a flat horizontal surface shaped to self-attach by magnetic attraction to a bottom surface of a flange of a girder of inverted T-profile.

17. The method of claim 14, wherein at least one of the clips has a web connected to the limbs, the web of has at least one bump, and step (c) includes positioning the clip so that the bump is positioned above the first flange when the protruding ledge is attached to the bottom surface of the flange.

18. The method of claim 14, further comprising reinforcing a portion of the peripheral rim of the tile with the protruding ledges of the clips.

19. The ceiling tile of claim 14, wherein the limbs of at least one of the clips include a lance for retaining the clip in the core.
